(19) United States
(12) Patent Application Publication
(10) Pub. No.: US 2016/0335171 A1
(43) Pub. Date: Nov. 17, 2016

(54) TEST AUTOMATION MODELING

(71) Applicant: HEWLETT PACKARD ENTERPRISE DEVELOPMENT LP, Houston, TX (US)

(72) Inventors: Matthew Charles Kenney, Fort Collins, CO (US); Daniel Dale Armstrong, Fort Collins, CO (US)

(21) Appl. No.: 15/114,379

(22) PCT Filed: Jan. 31, 2014
(86) PCT No.: PCT/US2014/014334

§ 371 Date: Jul. 26, 2016

(51) Int. Cl. G06F 11/36

(52) U.S. Cl. CPC G06F 11/3608; G06F 11/3664

(57) ABSTRACT

A method of modeling elements in an automated test of a software application is disclosed. An attribute is created for a set of user-interface elements of a selected species. The attribute defines interactions for the selected species. The user-interface elements are reduced to a primitive type. An application program interface can be used to apply the attribute to the software application.

### BACKGROUND

Many software applications are written as web-based applications to be run in an Internet browser. Web applications are often highly interactive and responsive and are typically implemented through a user interface (UI) such as a graphical user interface GUI. During the development of web applications, the LA's can be subjected to testing to determine if it meets the specifications of the software designer.

### BRIEF DESCRIPTION OF THE DRAWINGS

FIG. 1 is a block diagram illustrating an example test system.

FIG. 2 is a block diagram illustrating an example process for use with the test system of FIG. 1.

FIG. 3 is a block diagram illustrating an example process for use with the test system of FIG. 1.

FIG. 4 is a block diagram illustrating an example computing device for use with the test system of FIG. 1.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

UI testing is often performed through the use of a variety of test cases. A test case, which can also be referred to as a test script, is a set of conditions or variables under which a tester will determine whether an application, software system or one of its features is working as it was originally established for it to do. Test cases are usually collected into test suites. Test suites are created to cover the functionality of the processes and exercise the UI. A well-designed test suite addresses issues of domain size and the sequence of the UI events. For example, a software application may include hundreds or thousands of UI operations. Further, some functionality of the application is accomplished by following some complex sequence of UI events. These sequences may appear relatively straightforward to software designer, but a novice end user might follow a much more varied, meandering and unexpected sequence of UI events to achieve the relative simple goal. Well-designed test suites often simulate possible sequences of novice users.

Accordingly, UI testing is typically automated rather than performed manually. Test automation refers to using a software tool to run repeatable tests against the application to be tested. There are many advantages to test automation including the repeatability of the tests and the speed at which the tests can be executed. A number of commercial and open source tools available for assisting with the development of test automation.

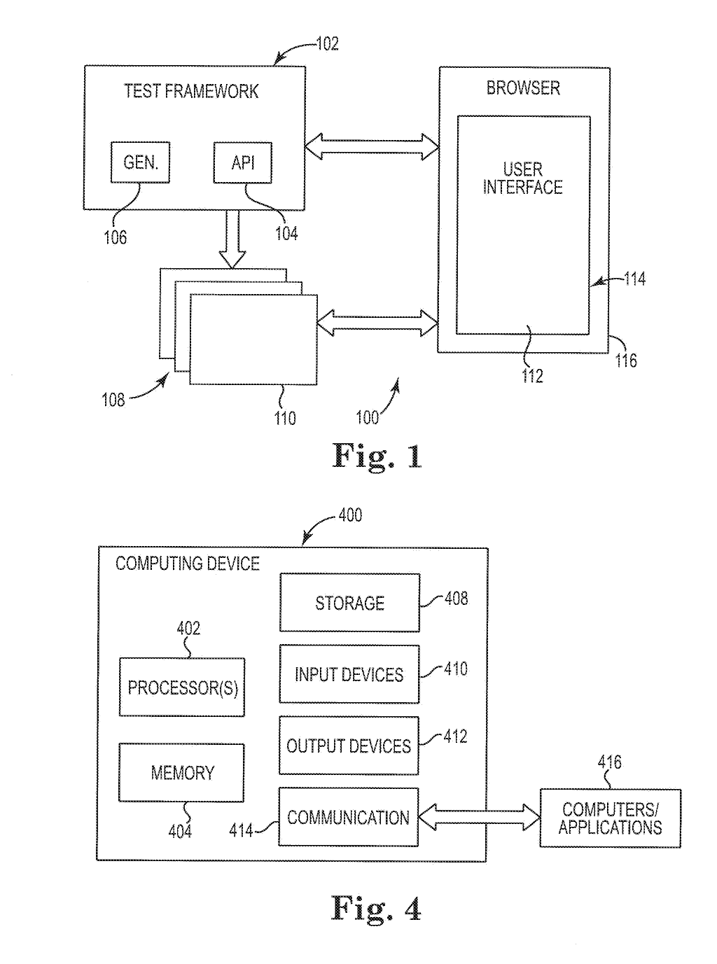

FIG. 1 illustrates an example test system 100. The test system 100 includes a test tool or framework 102 having an application program interface (API) 104 and an attribute generator 106. The framework 102 is configured to generate a test suite 108 including one or more test scripts 110 to test the functionality and performance of a target UI 112 of a software application 114, such as a web-based application. The framework 102 can also be configured to apply the test suite 108 to the UI 112 and to record test results, identify errors in the UI, or perform other business functions. In the example system 100, the UI 112 is implemented in a web browser 116.

The software application 112 can be configured in a variety of different architectures or models. For example, the software application 108 can be configured in a single tier model, or a monolithic application. A monolithic application includes a single application layer that supports the user interface, the business rules, and the manipulation of the data all in one, such as a traditional, stand-alone, word processor. The data itself could be physically stored in a remote location, but the logic for accessing it is part of the application. The UI is an integral part of the application. In a two-tier application, the UI and business rules remain as part of the client application. Data retrieval and manipulation is performed by another separate application, usually found on a physically separate system. In another type of two-tier application, the business rules are executed on the data storage system such as in applications that are using stored procedures to manipulate the database. With three-tier applications or n-tier applications, the business rules are removed from the client and are executed on a system in between the UI and the data storage system. The client application provides the UI for the system. In one example, the client application can include a browser and the n-tier application can be a web-based application.

Writing and maintaining automated web-based UI tests presents a considerable number of hurdles. Two large obstacles include the time to model the elements of a web UI along with the interactions with those elements and the maintainability of test scripts 110 built from those models.

In order to create an automated UI test, a test designer examines the Document Object Model, or DOM, of a web page to develop a strategy to identify elements on the web page. The designer also examines the layout and flow of the UI to determine which elements to identify and in what order those elements might interact to achieve a desired result. Further, the designer is typically intimately familiar with the API 104 to interact with the browser to retrieve information from and inject information into the UI. Accordingly, the development of tests is often time consuming processes performed by specialized and experienced personnel.

The designer also is concerned with maintainability of the test. If a single change in the design or structure of the UI 112 requires multiple changes to multiple tests, e.g. a login button is changed, resulting in changes to every test that clicks that button. This can present a problem in regression testing, which seeks to uncover new software bugs, or regressions, in existing functional and non-functional areas of a system after changes such as enhancements, patches or configuration changes, have been made. The UI 112 may change significantly across versions of the application 114, even though the underlying business rules may not. A test designed to follow a certain path through the UI may not be able to follow that path if a button, menu item, or dialog may have changed location or appearance. Automated test designers may spend as much time fixing the automation as they would have spent had tests been executed manually.

Current automated test products provide tradeoffs between ease of development and maintainability. Either tests are created rapidly with little experience but are maintained constantly and with great effort, or highly skilled developers are be employed to write tests with less, but still relatively high, maintenance cost,

In one example, the API 104 accepts commands and sends the commands to a browser. The API implemented through a browser-specific browser driver that sends commands to the browser, and retrieves results. One example of the API 104 includes Selenium WebDriver libraries, available in an Apache 2.0 license, which is implemented as libraries that can be imported in a number of different languages. These libraries define the API needed to access elements in a web browser. The libraries, however, do not define the flow of how various elements should interact, do not reduce elements to primitive types, and do not provide a mechanism for implementing interactions with elements based upon groups of similar element types. As a low-level implementation, Selenium WebDriver is implemented in a framework and supporting code and scripts to be usable.

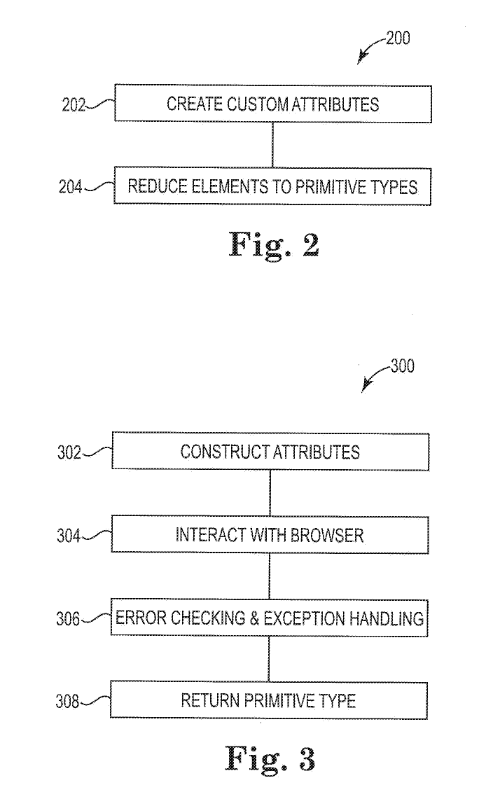

FIG. 2 illustrates a process 200 that can be implemented in system 100 to model a web page with much greater efficiency than can be achieved with currently available technology. Custom attributes can be created with attribute generator 106 for various element types at 202. Additionally, complex browser elements are reduced to primitive types at 204.

In one example, custom attributes are provided, at 202, in the C# (c-sharp) programming language to encapsulate web browser interaction driven by the API 104. The attributes generator 106 provides for the snippets of pre-defined code each corresponding with various element types of web elements, such as checkboxes, input boxes, buttons, etc., to be injected at run time. This reduces or eliminates explicitly defined browser interactions for individual elements. Instead, the attributes define interactions based upon element types. In an example provided below, the code used to implement automated interaction with elements is reduced from several dozen lines to only two lines. Accordingly, elements are modeled with significantly increased efficiency, which reduces the maintenance cost of the automated test framework.

Complex browser elements reduced to primitive types, at 204, are more intuitive and easier to manipulate when designing the flow control for an automated test. For example, a checkbox becomes a Boolean. In this example, the test developer does not “click” the checkbox, or retrieve the value of a checkbox. Instead, the test developer sets the modeled checkbox element or a particular page to true or false depending on whether that checkbox should be checked or unchecked, respectively. The value of the checkbox is retrieved as a Boolean type. Again, the complexity and length of the test automation scripts 108 and code are reduced, as are maintenance costs.

FIG. 3 illustrates an example of process 200 in more detail as process 300. The attributes for various elements encountered in the UI 112 are constructed with the attribute generator 106, at 302. For example, the attributes determine if the element is having information retrieved (get) or sent (set) to the UI element. The attribute generator 106 accesses the API 104 to allow the attribute the appropriate interactions with the browser 116, at 304. Error checking and exception handling are performed at 306. An appropriate primitive type is returned at 308. In one example, once the attributes are constructed for element types in a given page a page model can be created. In one example, the page model is represented by a class, such as a C# class. In this page model, elements of a given page are defined as properties of the page model class and are assigned primitive types. The attributes perform error checking on the types of the properties to ensure, for example, that a checkbox is of type Boolean and not of type String or other type.

An example of an attribute for an input box, defined as LookupInputAttribute, can be provided as follows:

```
public class LookupInputAttribute : OnMethodBoundaryAspect
    {
        private String key;
        private Boolean cache;
        private IWebElement element;
        public LookupInputAttribute(String key, Boolean cache = false)
        {this.key = key;
            this.cache = cache;
            this.element = null; }
        public override void OnEntry(MethodExecutionArgs args)
        {if (!this.cache || this.element == null)
            {try
                {this.element =
Fusion.Instance.Driver.FindElement(ElementMap.Instance[this.key]); }
                catch (NoSuchElementException ex)
                {throw new Exception(“Unable to find element \“” +
this.key + “\” on the page.”, ex); }
            }
            if (args.Method.Name.StartsWith(“get_”))
            {args.ReturnValue =
this.element.GetAttribute(“value”);
          args.FlowBehavior = FlowBehavior.Return; }
        else if (args.Method.Name.StartsWith(“set_”))
            {string value =
args.Arguments.GetArgument(0).ToString( );
this.element.Clear( );
while (!this.element.GetAttribute(“value”).Equals(value))
          {this.element.Clear( );
    this.element.SendKeys(args.Arguments.GetArgument(0).ToString( ));
    }
            args.FlowBehavior = FlowBehavior.Return; }
}
  }
```

The property can be defined and used in a page class as follows:

[LookupInput(“networkCreateName”)]
public string NotworkCreateName {get; set;}

In order to either send text to the input box or retrieve what is already set in the input box, the test simply calls (respectively):

pageClassInstance.NetworkCreateName = myTextBoxValue
myTextBoxValue = pageClassInstance.NetworkCreateName

Note that the attribute takes a single string input parameter. This parameter retrieves the identification information (via the ElementMap as seen in the attribute) for the element to make it identifiable in the UI. Thus, the test creator is not concerned with browser-level interaction and can rapidly model any other text boxes encountered in the UI by simply creating a parameter and assigning that parameter the appropriate attribute with identification information for that element.

The example systems and method include several advantages. Some advantages can include an increase in speed with which web pages can be modeled and a lower cost of maintaining those models and any logic and/or test cases associated with those models. With the custom-defined attributes, interaction logic and error checking can be coded once for all the modeled elements, which reduces the total code coverage for identifying and defining elements.

Applications undergoing development will see changes in its user interface. Thus, tests based on a particular UI are constantly modified and expanded as the UI changes. Using traditional solutions, any changes that are to be made to a group of elements—for example, that the browser-level API changes such that checkboxes are interacted with differently or the implementation of an integer input in the UI changes from an input box to a drop down menu—will occur for each single element, as well as changes to related issues such as logging support. Thus, the maintenance cost is proportional to the number of elements that need to be changed.

In an example of the present system and methods, browser-level interactions occur within a single custom-defined attribute for a given element type. If a change is occurs for how a user will interact with all checkboxes throughout the web-based application, or if additional error checking when inputting text into an input box is desired, this change occurs in the applicable attribute rather than in each element.

FIG. 4 illustrates an example computer system that can be employed in an operating environment and used to host or run a computer application included on one or more computer readable storage mediums storing computer executable instructions for controlling the computer system, such as a computing device, to perform the processes 200, 300. In one example, the computer system of FIG. 4 can be used to implement the framework 102 and be used to access the web-based application 114, including the UI 112, through the browser 116.

The exemplary computer system of FIG. 4 includes a computing device, such as computing device 400. Computing device 400 typically includes one or more processors 402 and memory 404 to implement processes 200, 300. The processors 402 may include two or more processing cores on a chip or two or more processor chips. In some examples, the computing device 400 can also have one or more additional processing or specialized processors (not shown), such as a graphics processor for general-purpose computing on graphics processor units, to perform processing functions offloaded from the processor 402. Memory 404 may be volatile (such as random access memory (RAM)), non-volatile (such as read only memory (ROM), flash memory, etc.), or some combination of the two. The computing device 400 can take one or more of several forms. Such forms include a tablet, a personal computer, a workstation, a server, a handheld device, a consumer electronic device (such as a video game console or a digital video recorder), or other, and can be a stand-alone device or configured as part of a computer network, computer cluster, cloud services infrastructure, or other.

Computing device 400 may also include additional storage 408. Storage 408 may be removable and/or non-removable and can include magnetic or optical disks or solid-state memory, or flash storage devices. Computer storage media includes volatile and nonvolatile, removable and non-removable media implemented in any suitable method or technology for storage of information such as computer readable instructions, data structures, program modules or other data. Test suite 108 can be configured in storage 408 or memory 404 A propagating signal by itself does not qualify as storage media.

Computing device 400 can be configured to run an operating system software program and one or more computer applications to execute the framework 102 and processes 200,300, which make up a system platform. A computer application configured to execute on the computing device 400 is typically provided as set of instructions written in a programming language and tangibly stored in the memory 404 and/or storage 408. A computer application configured to execute on the computing device 400 includes at least one process (or task), which is an executing program. Each process provides the resources to execute the program.

Computing device 400 often includes one or more input and/or output connections, such as USB connections, display ports, proprietary connections, and others to connect to various devices to receive and/or provide inputs and outputs. Input devices 410 may include devices such as keyboard, pointing device (e.g., mouse), pen, voice input device, touch input device, or other. Output devices 412 may include devices such as a display, speakers, printer, or the like. Computing device 400 often includes one or more communication connections 414 that allow computing device 400 to communicate with other computers/applications 416. Example communication connections can include, but are not limited to, an Ethernet interface, a wireless interface, a bus interface, a storage area network interface, a proprietary interface. The communication connections can be used to couple the computing device 400 to a computer network, which is a collection of computing devices and possibly other devices interconnected by communications channels that facilitate communications and allows sharing of resources and information among interconnected devices. Examples of computer networks include a local area network, a wide area network, the Internet, or other network. In one example, the browser 116 and target software application 114 are implemented on computing device 400 along with test framework 102. In another example, test framework 102 is implement in computing device 400 and is connected to the target software 114 on another device 416. Still further, test framework 102 can access additional resources from other devices, such as device 416.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method of modeling elements in an automated test of a software application, comprising:
creating an attribute for a set of user-interface elements of a selected element type, wherein the attribute defines interactions for the selected element type; and
reducing the user-interface elements to a primitive type.

2. The method of claim 1 wherein the selected element type includes one of checkboxes, input boxes, and buttons.

3. The method of claim 1 where the primitive type is a Boolean type.

4. The method of claim 3 wherein an element in the user-interface elements is set to true if the element is selected.

5. The method of claim 4 wherein the element in the user-interface elements is retrieved as a Boolean type.

6. The method of claim 1 wherein the attribute defines interactions based upon the selected element type.

7. The method of claim 1 wherein the software application is a web-based application.

8. A computer readable storage medium storing computer executable instructions for controlling a computing device to perform a method of modeling elements in an automated test of a software application, the method comprising:
creating an attribute for a set of user-interface elements of a selected element type, wherein the attribute defines interactions for the selected element type; and
reducing the user-interface elements to a primitive type.

9. The computer readable medium of claim 8 including constructing attributes for the selected element type in a page.

10. The computer readable medium of claim 9 including creating a page model class wherein the user-interface elements of the page are defined as properties of the page model class.

11. The computer readable medium of claim 10 wherein the attributes perform error checking.

12. A system to test a software application, comprising:
an attribute generator configured to create an attribute for a set of user-interface elements of a selected element type, wherein the attribute defines interactions for the selected element type and reduce the user-interface elements to a primitive type; and
an application program interface to apply the attribute to the software application.

13. The system of claim 12 wherein software application is a web-based application, and the application program interface applies the attribute to the web-based application through a browser.

14. The system of claim 13 wherein the attribute generator access the application program interface to interact with the browser.

15. The system of claim 12 wherein the attribute determines if a corresponding element is having information retrieved of sent.
